(19) United States
(12) Patent Application Publication
(10) Pub. No.: US 2016/0164391 A1
(43) Pub. Date: Jun. 9, 2016

(54) LINEAR MOTOR

(71) Applicant: HON HAI PRECISION INDUSTRY CO., LTD., New Taipei (TW)

(72) Inventors: MI-CHIEN CHEN, New Taipei (TW); CHI-HUAN SHAO, New Taipei (TW)

(21) Appl. No.: 14/688,758

(22) Filed: Apr. 16, 2015

(30) Foreign Application Priority Data
Dec. 8, 2014 (TW) 103142569

(51) Int. Cl. H02K 41/02; H02K 9/19

(52) U.S. Cl. CPC H02K 41/02; H02K 9/19

(57) ABSTRACT

A linear motor includes a base, a stator positioned on the base, a mover positioned in the stator and configured to move relative to the stator. The base defines a cooling passage being air communicating with outer environment for flowing fluid.

### FIELD

The subject matter herein generally relates to a driving mechanism, and particularly to a linear motor.

### BACKGROUND

One of the most common and important problems in the application of motors is the temperature rise resulting from various losses, such as copper losses, brush-contact loss, core loss, mechanical loss, stray load loss, etc. And, as well known in the art, the operating temperature of a motor is closely associated with its life expectancy, because deterioration of the insulation is a function of both time and temperature. Therefore, various cooling means or ventilating systems are proposed for such machines to remove the heat arising from the inevitable losses, and thus to prevent overheating of the machines.

### BRIEF DESCRIPTION OF THE DRAWINGS

Implementations of the present technology will now be described, by way of example only, with reference to the attached figures.

FIG. 1 illustrates an assembled, isometric view of a linear motor including a base.

FIG. 2 is an isometric view of the base of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A linear motor includes a base, a stator positioned on the base, a mover positioned in the stator and configured to move relative to the stator. The base defines a cooling passage being air communicating with outer environment for flowing fluid.

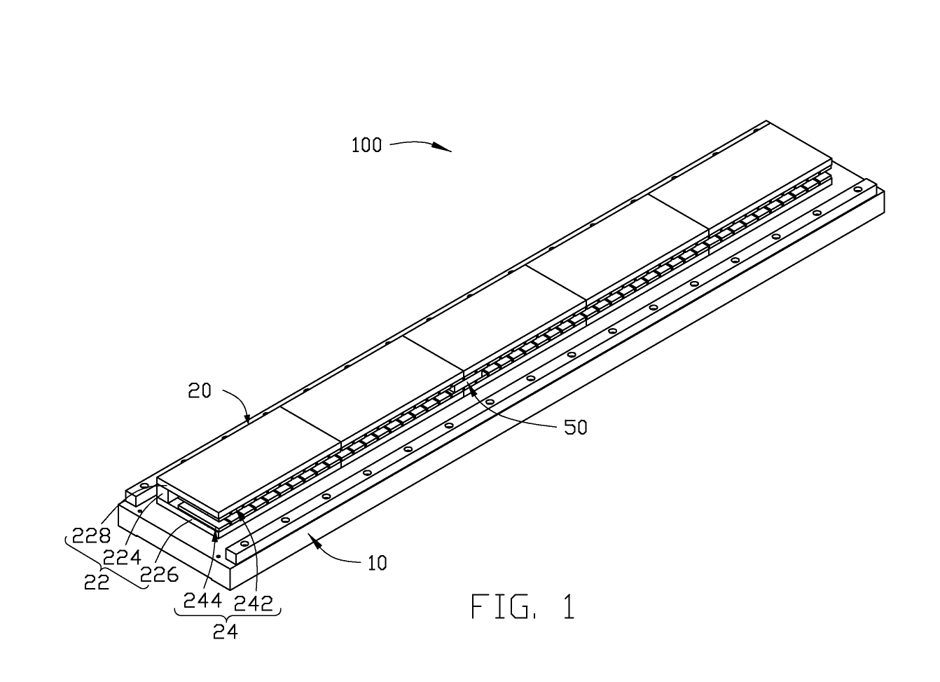

FIG. 1 illustrates a linear motor 100 including a base 10, a stator 20 positioned on the base 10, and a mover 50 positioned in the stator 20 and configured to move relative to the stator 20.

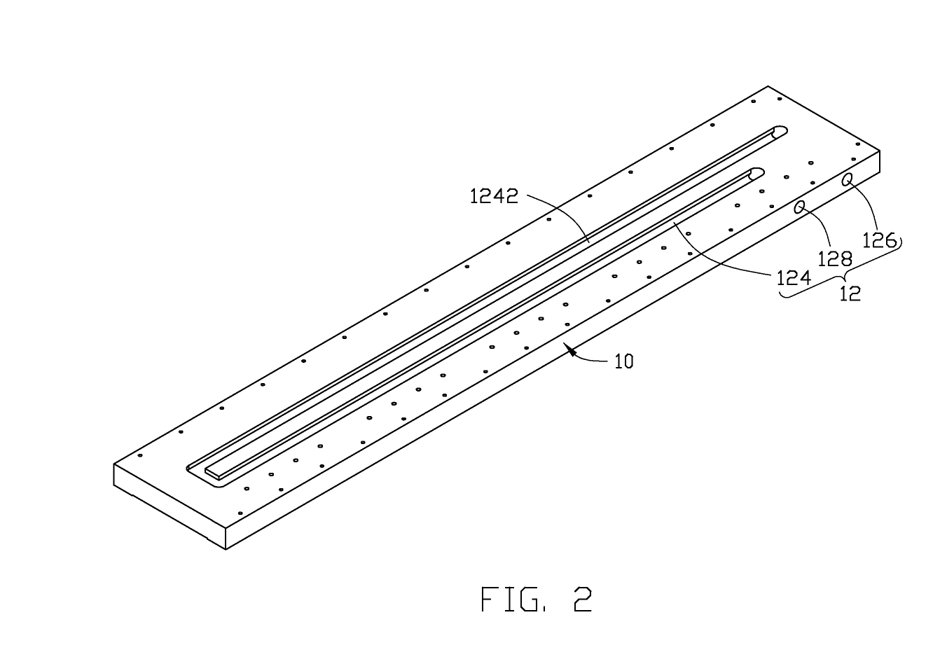

Also referring to FIG. 2, the base 10 can be a substantially rectangular board. The base 10 can define a cooling passage 12. The cooling passage 12 can be air communicating with an outer environment for flowing fluid. The cooling passage 12 can include a communicating portion 124, an inlet 126, and an outlet 128. The communicating portion 124 can be formed in the base 10. The communicating portion 124 can be substantially in a U shape and can have an opening 1242. The inlet 126 and the outlet 128 can be air communicating with the communicating portion 124 and separately defined in a sidewall of the base 10. The inlet 126 can be coupled to an outer device for providing fluid and gas, for guiding air or fluid into the communicating portion 124. The outlet 128 can be used for ejecting the fluid or air out of the base 10 to cool the base 10.

The stator 20 can be positioned on the base 10. In the illustrated embodiment, the stator 20 can include a stator support 22 and a permanent magnet group 24 positioned in the stator support 22. The stator support 22 can be positioned on the base 10. The stator support 22 can be in a U shape and include a first sidewall 224, a second sidewall 226, and a third sidewall 228. The second sidewall 226 can be fixed to the base 10 and cover the opening 1242. The first sidewall 224 can be interconnected between the second sidewall 226 and the third sidewall 228. The permanent magnet group 24 can include a first permanent magnet group 242 and a second magnet group 244. The first permanent magnet group 242 can be positioned on a side surface of the third sidewall 228 toward the second sidewall 226, and the second magnet group 244 can be positioned on a side surface of the second sidewall 226 toward the third sidewall 228.

The mover 50 can be positioned between the first permanent magnet group 242 and the second magnet group 244. In the illustrated embodiment, the mover 50 can have a coil (not shown). Magnet fields produced by the first permanent magnet group 242 and the second magnet group 244 can interact with a magnet field generated by the mover 50 to move the mover 50 relative to the stator 20.

In use, water or other cooling medium can be injected into the communicating portion 124 via the inlet 126 and ejected out of the base 10 via the outlet 128. Heat generated during the operation of the linear motor 100 can be transmitted to the stator 20. The work temperature of the linear motor 100 can be cooled down by operations of a fluid cooling system of the base 10.

In other embodiments, the number of the cooling passage 12 can be one more. The one more cooling passages 12 can be separately formed in the base 10. A shape of the cooling passage 12 can be designed to be in other shapes, such as in a linear shape or a Z shape. The cooling passage 12 can have a plurality of turnings. The opening 1242 of the cooling passage 12 can be omitted, and it can have a top sidewall. The inlet 126 and the outlet 128 can be not limited to be at a same sidewall of the base 10, they can be positioned at different sidewalls of the base 10.

The embodiments shown and described above are only examples. Many details are often found in the art such as the other features of a linear motor. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A linear motor comprising:
a base defining a cooling passage configured to be in communication with outer environment for flowing fluid;
a stator positioned on the base; and
a mover positioned in the stator and configured to move relative to the stator.

2. The linear motor of claim 1, wherein the stator comprises a stator support, a first permanent magnet group, and a second magnet group, the stator support is positioned on the base, the first permanent magnet group and a second magnet group positioned opposite sidewalls of the stator support, the mover is positioned between the first permanent magnet group and the second magnet group.

3. The linear motor of claim 2, wherein the stator support is in a U shape, the stator support comprises a first sidewall, a second sidewall, and a third sidewall, the second sidewall is fixed to the base, the first sidewall is interconnected between the second sidewall and the third sidewall, the first permanent magnet group is positioned on a side surface of the third sidewall toward the second sidewall, and the second magnet group is positioned on a side surface of the second sidewall toward the third sidewall.

4. The linear motor of claim 1, wherein the cooling passage comprises a communicating portion, an inlet, and an outlet, the communicating portion is formed in the base, the inlet and the outlet are communicating with the communicating portion and separately defined in a sidewall of the base.

5. The linear motor of claim 4, wherein the communicating portion is in a U shape.

6. The linear motor of claim 4, wherein the communicating portion has an opening towards the stator and covered by the stator.
